(19) United States
(12) Patent Application Publication
(10) Pub. No.: US 2016/0042726 A1
(43) Pub. Date: Feb. 11, 2016

(54) NETWORKED SENSOR FOR MUSICAL INSTRUMENT OR FOR MUSICAL INSTRUMENT CASE

(71) Applicant: Best Case Scenario, LLC, Nashville, TN (US)

(72) Inventors: Joe GLASER, Nashville, TN (US); Jonathan SEXTON, Knoxville, TN (US); Jed EATON, Knoxville, TN (US)

(21) Appl. No.: 14/821,478

(22) Filed: Aug. 7, 2015

Related U.S. Application Data
(60) Provisional application No. 62/111,898, filed on Feb. 4, 2015.
(60) Provisional application No. 62/034,979, filed on Aug. 8, 2014.

(51) Int. Cl. G10G 7/00; G06Q 40/08; G01N 25/56; G01P 13/00; G01M 99/00

(52) U.S. Cl. CPC G10G 7/005; G01P 13/00; G01M 99/00; G01N 25/56; G06Q 40/08

(57) ABSTRACT

A monitoring device is provided herein. The device is configured to reside within an instrument, or within a case for a stringed instrument or other environmentally sensitive object. The device includes a series of detectors. These may be a humidity sensor, a temperature sensor, a motion sensor, a magnetometer and a geo-location sensor. The device also includes a micro-processor that is configured to process signals received from the detectors and create a history of environmental events experienced by the instrument. In one aspect, the micro-processor initiates a signal in the event that a threshold event occurs. A method of monitoring environmental conditions with a case is also provided. Detected conditions are correlated to time and location, and may be analyzed using a remote user processor such as a tablet.

### CROSS REFERENCE TO RELATED APPLICATIONS

This application is related to U.S. Provisional Patent Appl. No. 62/034,979 filed on Aug. 8, 2014 and U.S. Provisional Patent Appl. No. 62/111,898 filed on Feb. 4, 2015, the contents of both incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The invention relates to sensing systems for the storage, shipping or transit of items. More specifically, the invention relates to the monitoring of movement and environmental conditions within a case for a stringed instrument or within a stringed instrument itself. The invention also relates to the strategic interaction of sensors to optimize individual monitoring needs, notification preferences and battery power management.

### TECHNOLOGY IN THE FIELD OF THE INVENTION

Professional musicians frequently play in different venues. Such musicians may be members of a symphony or orchestra who travel by bus, by rail or by airplane to provide concerts. Such musicians may alternatively be members of a band who travel by tour bus, by commercial bus, or by airplane for concerts or promotional events. Such musicians may alternatively be individuals who simply wish to carry an instrument on an airplane or ship an instrument by common carrier.

In any of these instances, the musician will likely be required to surrender the instrument under terms of carriage. This creates consternation on the part of the musician as the instrument may have significant financial value, sentimental value, or both. This consternation is heightened by the conditions in which the instrument will likely be transported. Cargo hulls are frequently subject to extreme temperatures, and luggage is not always handled in the most delicate manner by common carriers.

Some instruments such as brass horns may not be particularly sensitive to environmental conditions. However, most instruments, particularly acoustic instruments, woodwinds and drums can be extremely sensitive to changes in temperature, changes in humidity, and rough handling. The musician would want to know, preferably in real time, the condition of the instrument and its location. Unfortunately, there is no device on the market that allows the musician to really know the manner in which an instrument has been handled and stored.

Cases are used to offer protection, stability and security to their contents. Cases are known for securing valuable musical instruments. However, a case cannot protect a musical instrument or other sensitive equipment from an environment of extreme or beyond-recommended levels of temperature or extreme humidity. Further, a case will not protect an instrument from an extreme mishandling event or from being lost or stolen.

A need therefore exists for a monitoring device that records the handling of an acoustic instrument. Further, a need exists for such a monitoring device that records environmental conditions and location of the instrument during transit or during storage.

### BRIEF SUMMARY OF THE INVENTION

A monitoring device is first provided herein. The device is configured to reside within a case for a sensitive stringed instrument, or within a stringed instrument itself. The instrument is preferably an acoustic instrument such as a guitar, a mandolin, a violin, a dulcimer, a cello or a banjo. However, the instrument may alternatively be a horn, a keyboard or other equipment subject to handling damage, rust or the effects of heat, misplacement or theft.

In one aspect, the monitoring device first includes a real time clock. The clock works in connection with a controller.

The device further includes a series of detectors. A first detector is a motion sensor, such as an accelerometer. The accelerometer is configured to generate a motion signal in response to threshold movement of the device. The accelerometer also determines a degree, duration and force history associated with the threshold movements and logged to using the real time clock. The accelerometer signals are sent to the controller which processes and stores the signals as a function of time and geo-location.

A second detector may be a humidity sensor. The humidity sensor generates humidity signals. The humidity signals are sent to the controller which processes and stores the signals as a function of time and geo-location.

A third detector may be a temperature sensor. The temperature sensor generates temperature signals. The temperature signals are sent to the controller which processes and stores the signals as a function of time and geo-location.

A fourth detector may be a magnetometer. The magnetometer generates directional orientation signals to measure the strength and, in some cases, the direction of the magnetic field at a point in space. The magnetic orientation signals are sent to the controller which processes and stores the signals as a function of time and geo-location.

The device also includes the controller. The controller is a micro-processor that is configured to process signals and create a history of environmental, locational or traumatic physical events within the case. Environmental events may be a history of temperature, humidity and movement of the case. In one aspect, the micro-processor initiates a real-time signal in the event that a threshold event occurs.

The device also comprises a communications port. In a preferred aspect, the communications port wirelessly communicates the determined threshold events and durations associated with each movement, and the generated humidity and temperature histories. Signals are transmitted to a receiver remote from the device. The receiver may be, for example, an electronic PDA, a digital watch, a cell phone or a tablet.

Preferably, the communications port comprises a transceiver configured to wirelessly transmit the processed signals. Preferably, the communications port communicates the events and generated work function to the receiver substantially continuously, or at designated intervals controlled by the device manufacturer, the instrument manufacturer or instrument user/owner to optimize power consumption and battery life. These controlled power-up and power management parameter settings may be subject to override in response to user preference regarding trigger events. Signals may be sent to an owner of the contents of the case through a wireless telecommunications network. Alternatively or in addition, signals may be sent to an insurer of the contents of the case. Alternatively, signals may be stored for later upload. In this instance, the communications port defines a so-called flash drive for uploading data directly to the hard drive of a general purpose computer.

In one aspect, the transceiver communicates with a global positioning system (GPS) receiver for monitoring a location of the device, and the case or instrument to which it is attached. In this instance, the monitoring device also includes a geo-position detector. Thus, events may be associated not only with time, but also with location.

In one aspect, the device further comprises a battery. The battery is configured to supply power to at least the controller and the transmitter. In one aspect, the device further comprises an identification tag and a tag reader (such as RFID or other technology/protocol tag) to evaluate the unique identification and presence of a tagged instrument or entity.

A method for monitoring the condition of a stringed instrument is also provided herein. The method involves placing a monitoring device into the case, wherein the case is configured to hold one or more stringed instruments or any other sensitive object. The monitoring device may be in accordance with any of the embodiments described above for monitoring environmental conditions of the case.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1A is a perspective view of a case for a stringed instrument. The illustrative case receives a monitoring device of the present invention. In FIG. 1A, the case is in its closed position.

FIG. 1B is another perspective view of the case of FIG. 1A. Here, the case is in its opened position.

FIG. 1C is a perspective view of a musical instrument. The illustrative instrument is an acoustic guitar. Here, a portion of the interior of the instrument is visible through its sound hole.

FIG. 2 is an illustration of an example of a monitoring device with a usb communications port as may be used for monitoring environmental conditions in a case for a stringed instrument, in one arrangement. A series of optional remote user processors is shown in wireless communication (shown as “I”) with the monitoring device.

FIG. 3 is a circuit diagram for the monitoring device of the present invention, in one embodiment.

FIG. 4 is a flow chart showing general operation of a controller for the monitoring device. Functions of a host computer are also listed.

A list of “Smart Case Modes” is provided near the end of the specification. These represent different modes that may be selected by a user, with each mode having pre-defined settings.

### DETAILED DESCRIPTION OF CERTAIN EMBODIMENTS

### Definitions

As used herein, the term “instrument” refers to any sensitive device. Illustrative examples include acoustic musical instruments, electrical stringed instruments, tennis racquets, drums, horns, keyboard instruments, sound reinforcement equipment, and cameras.

### Description of Selected Specific Embodiments

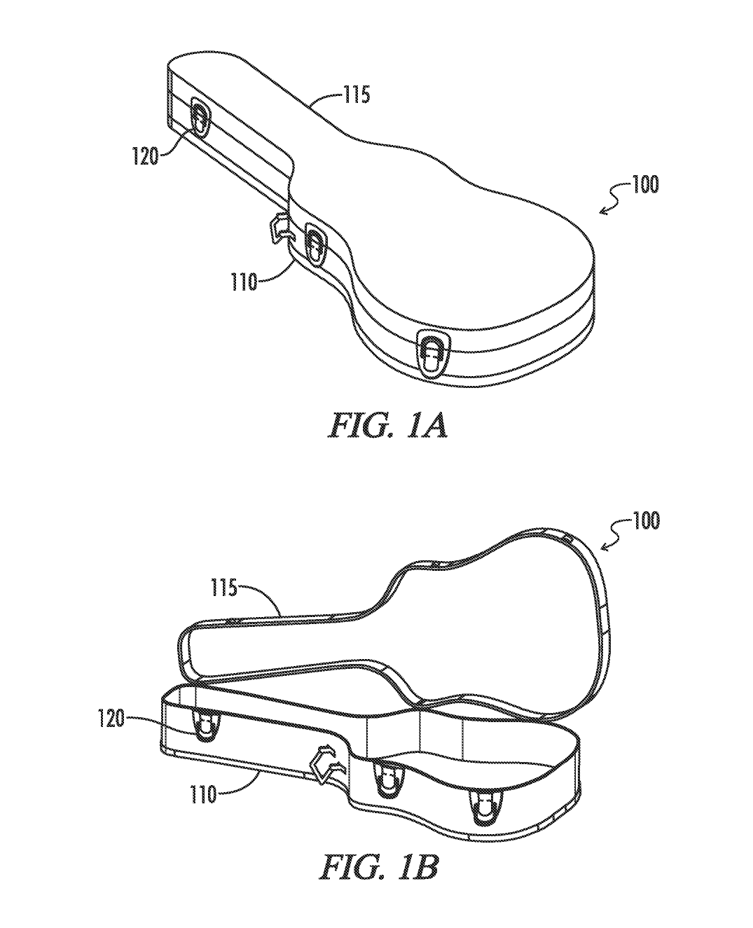

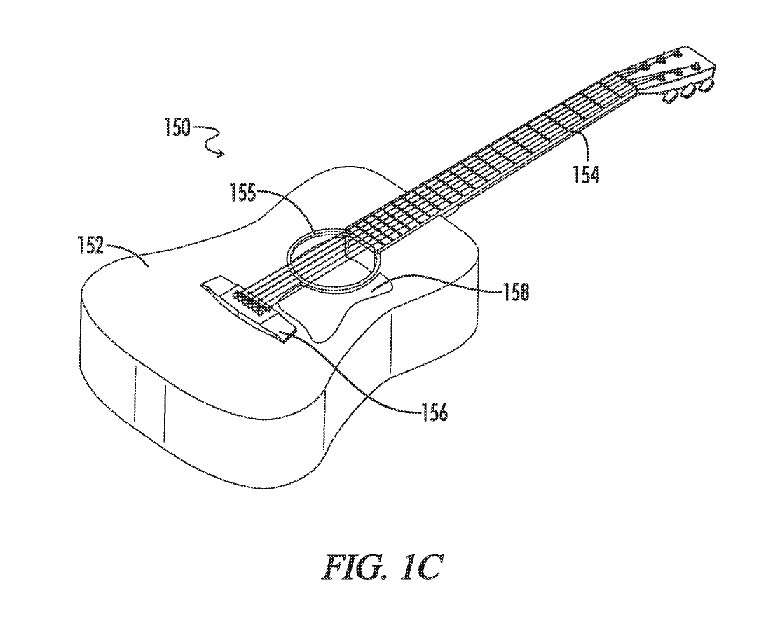

FIG. 1A is a perspective view of a case 100 for a stringed instrument. The illustrative case 100 is configured to hold an acoustic guitar. However, it is understood that the case 100 may be configured to hold a violin, a dulcimer, a mandolin, a banjo, a cello, or other acoustic or electric instrument. Alternatively, the case 100 may be configured to house a drum, a horn / brass instrument, or keyboard instruments. Any of these instruments may be fitted with electrical connections, cables or pick-ups.

As an alternative, the case 100 may be configured to hold a set of tennis racquets or other sensitive object such as sound reinforcement equipment or a camera.

In the illustrative arrangement of FIG. 1A, the case 100 includes a base 110 and a and a lid, or cover 115. In the view of FIG. 1A, the cover 115 is in its closed position, protecting contents (not shown) in the case 100.

FIG. 1B is another perspective view of the case 100 of FIG. 1A. Here, the case 100 is in its opened position. The case 100 includes latches 120 which have been released to allow the cover 115 to open as is well known in the art. Of course, other closure mechanisms may be used for an instrument case such as a zipper.

In the present disclosure, the case 100 is intended to receive a monitoring device (not shown in FIG. 1A or 1B). The monitoring device detects various environmental conditions within the case, and records them in memory associated with a micro-processor. Additionally, the device preferably includes a transmitter that enables a wireless communication of sensed conditions to the owner of the case 100 and its contents. Such conditions may include temperature, humidity, geographic location, unique identification, presence, and threshold movement.

FIG. 1C is another photographic view of a musical instrument 100. The illustrative instrument 100 is an acoustic guitar. Several components of the guitar 100 are indicated. These include the body 152, the fingerboard 154, the saddle / bridge 156 and the pick guard 158 (located on the body 152). It is understood that the fingerboard 154 will include strings and frets. It is also understood that the guitar 100 will have other components which are not indicated numerically, such as a head, tuning keys (or tuners), and any electrical pick-ups.

The guitar 100 of FIG. 1C also has a so-called sound hole 155. The sound hole 155 permits acoustic energy to resonate from the body 152 in response to string vibrations (as is known in the art). A portion of the interior of the guitar 100 is visible through the sound hole 155. In this embodiment, a monitoring device (not visible) resides within the interior of the instrument 100 itself.

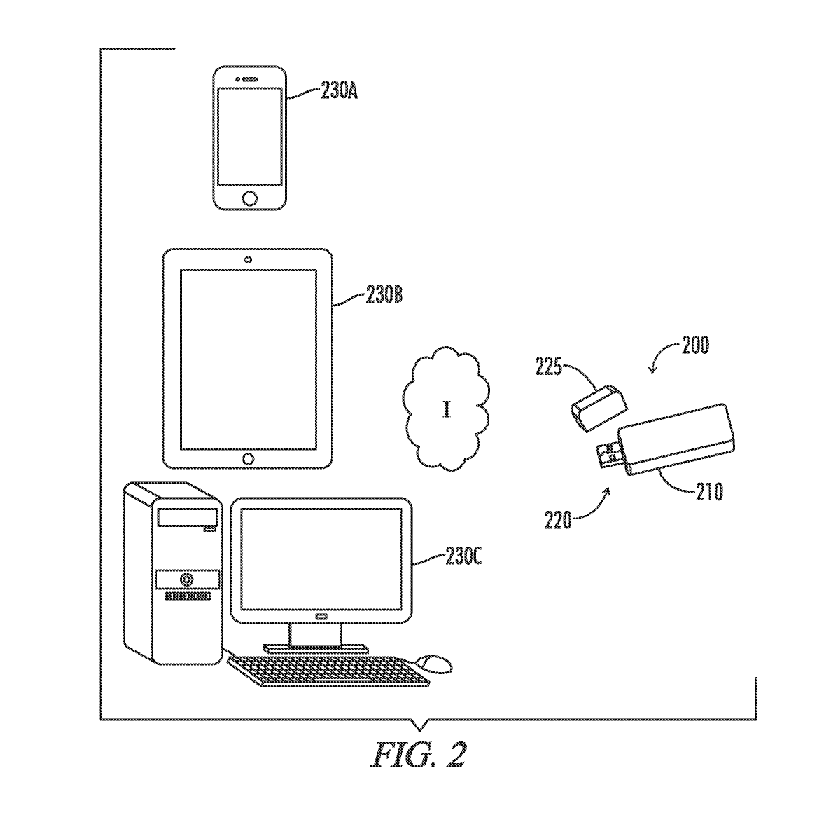

FIG. 2 is a perspective view of a monitoring device 200 as may be used for monitoring conditions of a case for a sensitive stringed instrument, in one arrangement. In this arrangement, the monitoring device 200 comprises a housing 210 and a communications port 220. In the arrangement of FIG. 2, the communications port 220 is a USB or flash-drive configured to upload data to the hard drive or the processor of a general purpose computer. Of course, the communications port 220 may alternatively be, or in addition be, a transmitter or transceiver for emitting wireless signals to a remote user processor.

In FIG. 2, a series of optional remote user processors is shown in wireless communication with the monitoring device 200. A first control unit 230A represents a so-called smart phone, or personal digital assistant. The personal digital assistant 230A includes a display that serves as a user interface. Examples of a suitable personal digital assistant include the iPhone® from Apple, Inc. of Cupertino, Calif., the Samsung® Galaxy of Samsung Electronics Co., Ltd. of the Republic of Korea, and the Droid RAZR® provided by Motorola, Inc. of Schaumburg, Ill. (It is acknowledged that Motorola, Inc. (or its telecommunications-related assets) may now be owned by Google, Inc. and that trademarks are likely owned by a trademark (or other IP) holding company out of Cerritos, Calif.)

It is noted that the idea of a personal digital assistant has expanded of late. Today, a PDA may be more than an intelligent smart phone; it may alternatively be a watch, a vehicle, a home monitor or an independent tablet. Any of these may generally be referred to herein as a remote user processor.

A second illustrative control unit 230B is a so-called tablet. The tablet 230B includes a display that serves as a user interface. Examples of a suitable tablet include the iPad® available from Apple, Inc., the Google® Nexus tablet, the Samsung® Galaxy tablet, the Amazon® Kindle Fire tablet, the Lenovo® ThinkPad tablet, and the Microsoft® Surface tablet. Tablets are also considered personal digital assistants.

A third illustrative control unit 230C represents a general purpose computer. The computer 230C also includes a display that serves as a user interface. General purpose computers may include the iMac® available from Apple, Inc., the Connectbook™ available from Hewlett-Packard Development Company, L.P. of Houston, Tex., the Inspiron® from Dell Computer Corporation of Round Rock, Tex., and the ATIV® from Samsung Electronics Co., Ltd.

Where a personal digital assistant 230A or a tablet 230B is used as the processor, a dedicated software application, or “App,” will need to be uploaded. Where a general purpose computer 230C is used as the processor, a software package may be downloaded from the Internet or uploaded from a so-called thumb drive or other device having memory. A web-based application may be used.

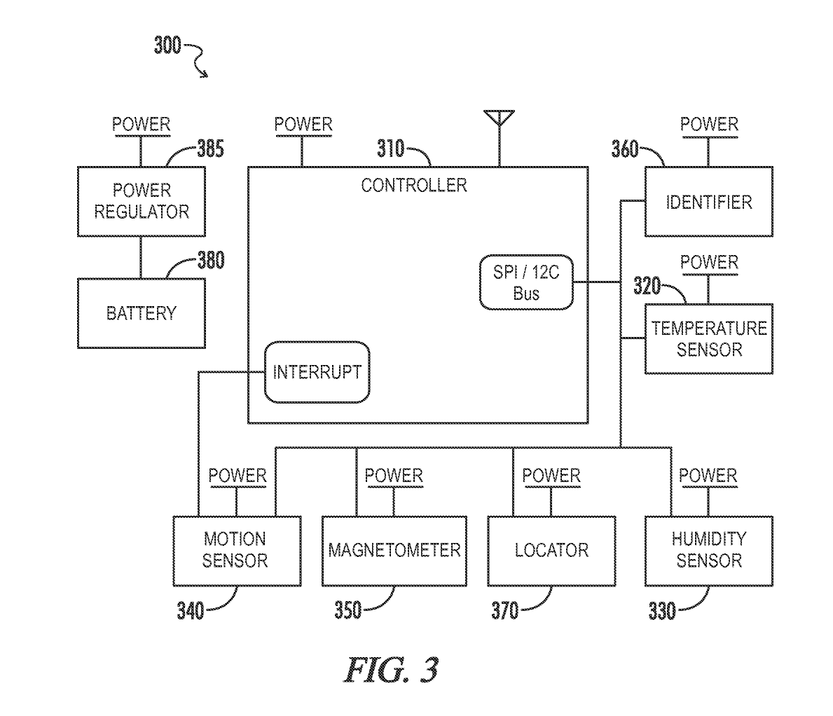

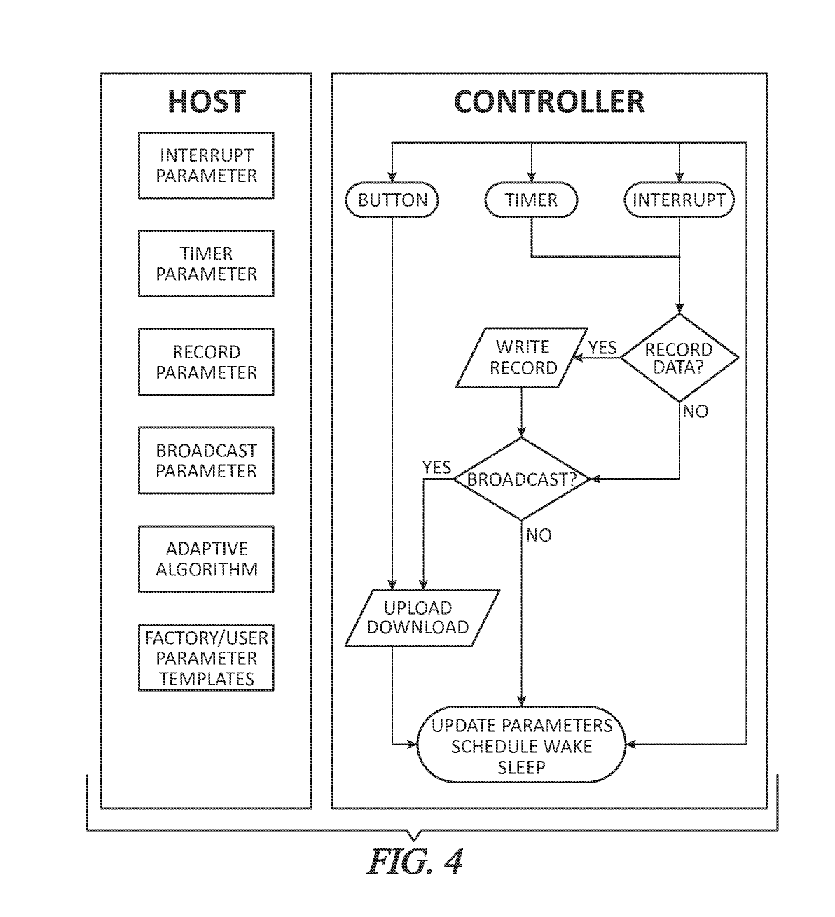

In any of the remote devices 230A, 230B, 230C, a wireless signal is sent to one or more monitoring devices. This will require the monitoring device 200 to have a transceiver (shown in FIG. 3 at 305) capable of generating wireless signals. Such signals are preferably cellular-based signals sent through a wireless telecommunications network (identified in FIG. 2 as “I.”)

The monitoring device 200 may include a cover 225. In the arrangement of FIG. 2, the cover 225 is configured to removably cover the USB connector 220.

FIG. 3 presents a circuit diagram for a monitoring device 300 of the present invention, in one embodiment. The monitoring device 300 may be in accordance with the monitoring device 200, except that a USB connector 220 is not shown as a communications port in FIG. 3.

The monitoring device 300 first includes a controller 310. The controller 310 may be a micro-processor or other processor that uses hardware, firmware, software or combinations thereof to receive, store and process signals. The controller 310 will have a real time or general purpose clock for correlating signals received by the controller 310 with time.

The monitoring device 300 also includes a temperature sensor 320. The temperature sensor 320 makes temperature readings. The temperature readings may be from inside of a case, or of the interior of the instrument, such as guitar 150. The temperature sensor 320 then sends signals indicative of the temperature readings to the controller 310 for processing and transmission.

The temperature sensor 320 provides a low power method for measuring temperature. The temperature is measured continuously or, alternatively, on a time interval based on preset or user settings. The temperature sensor 320 can measure the environment temperature within the case, or a surface temperature of the case, or the interior of the instrument 150 itself. In one aspect, the controller 310 is programmed with designated upper and lower temperature thresholds. When a threshold is breached, the controller 310 is placed in an “awake” mode and initiates a communication path in order to alert the user of temperature-induced stress. Threshold levels and frequency of communications/alerts can be set to parameters to optimize battery life. These parameters and levels can be graphically displayed in an “App” to allow a user a wide choice or continuous spectrum of power management plans and battery life.

The monitoring device 300 also includes a humidity sensor 330. The humidity sensor 330 makes humidity readings inside of the instrument or the case, and sends signals indicative of the humidity readings to the controller 310 for processing and transmission.

The humidity sensor 330 provides a low power method for measuring environmental moisture content. The humidity is measured on a time interval based on preset or user settings. In one aspect, the controller 310 is programmed with a designated humidity threshold. When that threshold is breached, the controller 310 is placed in an “awake” mode, and initiates a communication path in order to alert the user of the humidity condition and the stress being put on the instrument 150.

It is noted that tracking temperature and humidity can have benefits for making a warranty claim. The sensors 320, 300 may also have benefit in storage business arrangements, or bailments. The controller 310 records data from the sensors 320, 330 to create a history of temperature and humidity readings, which enables either the user or a bailee to determine whether environmental / contractual requirements have been met, breached, or exceeded.

The monitoring device 300 further includes a motion sensor 340. The motion sensor 340 makes readings reflecting certain threshold motion events inside of the instrument or inside of the case, depending on application, and sends signals indicative of the motion readings to the controller 310 for processing and transmission.

The motion sensor 340 is preferably an accelerometer. The accelerometer 340 provides a low power method for measuring shock and acceleration in one or more axes. The accelerometer 340 is preferably configured to record data in constant mode, but may alternatively by arranged to be used in an interrupt fashion based on a preset or user defined threshold. When a threshold is breached, such as when the instrument 150 is dropped, the controller 310 is placed in an “awake” mode, and initiates a communication path in order to alert the user of the motion. For example, when a threshold amount of sustained shock is measured by the accelerometer 340, a signal may be sent to trigger Bluetooth to broadcast or to connect to 3G for extended tracking.

The monitoring device 300 may further include a magnetometer 350 as a fourth sensor. The magnetometer 350 works in conjunction with the accelerometer 340 to realize an orientation independent electronic compass that can provide accurate heading information. Transportation or movement can be distinguished from bump or drop events by interpreting the accelerometer data in conjunction with the magnetometer data. Thus, the magnetometer 350 interacts with the accelerometer 340 to differentiate between an awakening event that compromises bumping, versus an event that includes rotation with reference to the magnetic pole, thereby indicating geographical movement.

In one setting, the user may specify zero motion tolerance. The device will then idle in a sleeping or low energy state until the accelerometer 340 or the magnetometer 350 is triggered by any movement at all. At that event, a communications path such as Bluetooth can be activated to communicate out over Bluetooth or other peripheral communications vector in order to alert the user. This is particularly beneficial for monitoring theft, where movement is not expected.

The monitoring device 300 also preferably includes an identifier 360. The identifier 360 may be an RFID transmitter, or reader. Radio frequency identification provides a method for unique identification of an object, such as case 100, being monitored. RFID also provides a method to detect the presence of an object being monitored, such as guitar 150, within a case 100. The RFID reader communicates with an RFID tag that is implanted in the stringed instrument 150. A user scans his or her instrument's unique ID into the identifier. If there is no instrument in the case (or at least the identified instrument is not in the case), then the controller 310 goes into a sleep mode and the transmitter 305 makes no broadcast, thus saving power and data. Alternatively, the processor 310 can wake at predefined or user-set intervals and enable the tag reader to check the presence or absence of the instrument 150.

If there is an instrument 150 in the case (meaning the identified instrument is in the case 100), then the controller 310 goes into awake mode to receive signals from the temperature sensor 320, the humidity sensor 330, and the motion sensor 340. Alternatively, the controller 310 may remain in sleep mode until the controller 310 observes a pre-determined change in humidity or temperature or motion. The RFID system is activated to determine whether the instrument 150 is in the case 100. For example, the accelerometer 340 may send a signal when the case 100 is moved, or when the guitar 150 is knocked over or dropped.

RFID provides a method for OEM suppliers to extend functionality in order to honor warranty where there is a uniquely identifiable recorded history of data. For example, establishing the actual presence of a known object in its controlled environment affects the user's and manufacturer's rights around the honoring of the warranty of a wooden object that clearly was or was not in a controlled environment. In addition, where multiple “instruments” are stored in multiple cases, radio frequency or other protocol can locate, organize or assure correct casing of “instruments.”

RFID can be employed as a tool by a manufacturer to link or provide thresholds. Threshold parameters can be provided directly to the system from an RFID tag that has been programed by the manufacturer or simply linked to an app layer with a preset identification scheme. RFID can also provide an inherent tamper proof mechanism for manufacturers to validate data which has been presented for warranty claims.

In another aspect, the owner of a guitar is provided with data that determines the environmental conditions of the guitar while the guitar is in transit or is otherwise being held in a bailment. The identifier 360, or reader, can determine and log the time-stamped presence or absence of a stored entity equipped with a trackable tag, during bailment. In still another aspect, the owner of a guitar is provided with data that determines the environmental conditions of the guitar, which can later be used in making an insurance claim. In this respect, the owner has proof that the guitar has not been exposed to harmful environmental conditions.

In yet another aspect, an airline or bus or hotel (or other bailee) can utilize the device 300 to monitor conditions during a period of bailment, and to confirm that a case 100, or an instrument 150 within the case 100, has not been exposed to harmful environmental conditions.

As noted, the monitoring device 300 also includes a transmitter 305. The transmitter 305 may operate using Bluetooth or Bluetooth Low Energy (“Bluetooth LE”) protocol. Bluetooth LE provides a low power communication platform for delivering measurement data to a mobile device as well as receiving measurement parameters from a mobile device. Bluetooth LE can also be used to connect to other modules for extending measurement or communication capability.

Cellular communication such as GSM, 3G, 4G or other provide a method to extend range beyond that of Bluetooth and Bluetooth LE. This can be in the form of an embedded module or a separate system which can receive data over Bluetooth, SPI, I2C or any other communication method. Cellular communication provides a method for OEM suppliers to extend capability for applications where the value of the device being measured merits this type of cost, for example, a priceless wooden instrument which is sensitive to shock, vibration, and humidity.

While 3G, 4G, or other cellular communication use can be expensive because of the need for a telephone account, a prepaid account with limited minutes of use can be enabled to allow a low cost expansion of the long distance broadcast capability. Because of the “smart” time and power management feature of the monitoring device 300, a minimal prepaid account would be sufficient for most usage.

Other communication technologies such as Zigbee, Tile, or other emerging protocols can also be used to extend the communication range of the device.

The monitoring device 300 preferably also includes a geo-position device, or locator 370. The transmitter technology can be leveraged for geo-location. The locator 370 preferably uses a satellite-based global positioning system to provide a method for geo-location of the case 100. The locator 370 can be in the form of an embedded GPS module or a separate system which can communicate over Bluetooth. Beneficially, the user can specify the behavior of GPS, when it is on, what events turn it on, etc. A prepaid 3G, 4G or other mobile device can act as a transmitting GPS geo-locator for on-demand monitoring of the case location. Alternatively GPS data can also be taken from a smartphone, tablet, or other equipped device when communicated over a short range protocol such as Bluetooth or Bluetooth LE.

The monitoring device 300 is preferably powered by a small battery 380. However, the various electrical components, particularly the RFID identifier 360, the transmitter 305 and short and long term storage of data, will consume battery life. Accordingly, in one embodiment the monitoring device 300 includes a power regulator 385 that optimizes and manages power usage. The regulator 385 regulates power levels based on sensor events.

High power use processes like 3G, 4G broadcast or RFID identification are limited by being triggered only at time intervals and/or at alarm events like movement or parameter readings exceeding threshold limits. “Smart,” pre-defined sequences of events can greatly reduce power consumption, extend battery life/recharge intervals and make a multi-sensor case insert feasible.

It is preferred that wireless signals be sent by the transmitter 305 to a remote user processor such as a personal digital assistant (smart phone, mobile computing device, tablet, etc.) The personal digital assistant communicates with the monitoring device using an application layer, or software. Alternatively, a general purpose computer may be used that communicates through a website platform. In either instance, the remote user processor provides the flexible platform to display data and manipulate user parameters as they relate to the target application. For example: a smartphone application enables the user to control environmental thresholds and reporting actions, e.g. when temperature is above X degrees, that event would wake the rest of the module to broadcast a datagram over Bluetooth and, after a predefined interval of no interaction, re-broadcast using 3G. This may enable 3rd party concierge case services which feature a link between a broadcast receiver and web loaded information regarding an instrument or collection.

As can be seen, a monitoring device for a musical instrument, or for a storage case for a stringed instrument, is provided. The device monitors musical instruments, or other sensitive stringed equipment, while in a case during transport or storage, or even during daily use. The device leverages emerging smartphone technology for data storage and user interaction to provide a customizable experience. Data is stored and recalled on the users mobile device. Data may also be sent to and stored in a remote database managed by a user, the manufacturer, or any other entity for use in warranty validation or any other purpose. User devices or dedicated/permanently installed devices can facilitate local data capture as well as remote database data exchange. Data can also be sent directly to a remote database in installations where cellular communication is available.

The monitoring device 300 functions on a battery 380 and is optimized for low power. The device 300 transmits data to a mobile user processor for on-demand viewing and long term display and storage. The monitoring device 300 can be permanently installed as an OEM instrument solution, or as an OEM case solution. Alternatively, the monitoring device may 300 be procured as a standalone portable module which is placed into an existing instrument or case.

The device 300 monitors temperature, shock, humidity, presence, unique identification, and/or location by logging or broadcasting events according to user selectable settings. Logged events are stored on the controller 310 or local memory and then uploaded to the mobile remote user processor. Regular reports, alarm events and data are communicated through Bluetooth Low Energy or other communications protocol. Data is ultimately stored and recalled on the mobile device. The mobile device 230 provides the ability to set up measurement frequency, alarm thresholds, and broadcast behavior. This allows the user to know if disturbances have occurred during transport as well as when and where disturbances occurred.

The user can control whether data is logged at all times or only when threshold conditions are met. The user can specify the length of time based measurement intervals. The user can specify when the device broadcasts updates to the remote user processor / mobile device. Broadcasts may be made periodically, on motion, on temperature, on humidity, on location change, on removal of tagged item, on low battery conditions or on combinations of these.

The user of the monitoring device 300 may be the owner of an individual instrument, or the owner of other sensitive cargo. Alternatively, the owner may be an instrument or device manufacturer, a case manufacturer, an insurance company, or a shipping company.

It is noted that an instrument manufacturer, when evaluating a warranty request related to damage of the type expected from extreme low temperature or humidity, could require a history showing that the case temperature/humidity was kept within specifications and the instrument was stored in the case. Thus, as noted above, the monitoring device 300 serves as verification for a warranty claim or, alternatively, for an insurance claim or a damages claim.

A single remote user processor 230 may track multiple monitoring devices. An application on a smartphone 230A (or other) device allows for a grid of decisions which relate to the monitoring parameters and behavior. The monitoring devices may be activated remotely, and threshold parameters may be adjusted remotely in an individual or group fashion.

The application may offer templates that pertain to certain types of instruments such as an acoustic guitar or an electric guitar. An acoustic guitar will have a different alarm threshold in terms of humidity and temperature than an electric guitar. The user can pick a generic acoustic template, an instrument manufacturer's template spec, or create the user's own parameter set. Templates can be manufacturer specific and/or manufacturer provided. A manufacturer can utilize this system and its data to validate warranty coverage around a history of compliance. This same process that the mobile application provides (user control of basic measurement parameters and reporting behavior as well as data display and storage) can be tailored to any specific use of the technology. These “templates” can be built in or created and saved and can display predicted battery life to enable a user to choose best selections, allowing users to optimize battery life.

A list of “Smart Case Modes” is provided. These represent different modes that may be selected by a user, with each mode having pre-defined settings. Such modes include:
A mode for long term storage with no concerns about theft or disturbance;
A mode for long term storage with concern over movement so that location can be tracked, wherein the accelerometer is left on for triggering GPS tracking;
A mode for short term storage with concern over movement so that location can be tracked, wherein the accelerometer is off but can be turned on remotely;
A travel mode where all sensors are running except GPS, which can be activated by the accelerometer, or remotely pinged if lost; and
A manufacturer mode for periodically sampling humidity and temperature within the case.

In one aspect, the user can specify broadcast addresses to one or more recipient and in any order or sequence and dynamically depending on response or lack thereof: manual entry of an OK, change in critical parameter, time lapse without connection etc. In one example, if a humidity reading shows that a humidity level in a case has dropped below a set parameter and an instrument is in danger of cracking, the periodic humidistat reading—a low power event—triggers the monitoring device to initiate a check of temperature, presence of the instrument in the case and, only then, turns on the Bluetooth transmitter, looks for the mobile device pairing and records contact. The frequency of humidity measurements then increases. If the humidity level does not moderate within the preset time parameter, communication escalates to cellular or other longer distance communication, and a higher power consumption level component. Successful interaction with the remote mobile device then puts the case insert back into a hibernation state with only low power periodic sensor readings. Failure to interact with a remote mobile device would open a regular 3G calling schedule, waking the 3G device only at regular intervals to broadcast.

Additional detail about the Smart Case Modes in one or more embodiments of the device are as follows:

1. Long Term Secure Storage, known location—Environmental Monitors are on, no Theft concern.

a. The Radio Frequency Identification Tag (RFID) Instrument Presence Sensor is off.

b. The Humidity Monitor turns on for slow sample rate: for example, 1 time per day, with a report cycle of 1 time per day.

c. The Temperature Monitor turns on for slow sample rate: for example, 1 time per day, with a report cycle of 1 time per day.

d. The Accelerometer off. Theft/disturbance concern is nil.

e. The GPS (Global Positioning Satellite Location) turns on: for example, 1 time per day, with a report cycle of 1 time per day.

f. The Bluetooth Low Energy broadcast (BLE) turns on for reporting, for example, 1 time per day at 10 p.m. per the User's setting.

g. The 3G Cellular Phone Broadcast or similar technology (3G) is off.

2. Long Term Secure Storage, known location—Environmental Monitors are on, Theft concern low but present.

a. The Radio Frequency Identification Tag (RFID) Instrument Presence Sensor is off but can be triggered by the Accelerometer.

b. The Humidity Monitor turns on for slow sample rate: for example, 1 time per day, with a report cycle of 1 time per day.

c. The Temperature Monitor is set on for slow sample rate: for example, 1 time per day, with a report cycle of 1 time per day.

d. The Accelerometer on. Any movement triggers the GPS, which tests for a location change.

e. The GPS, if triggered and detecting a location change, triggers BLE and 3G.

f. The BLE, if triggered, wakes and transmits every 10 minutes or per the User's setting.

g. The 3G, if triggered, wakes and sends a message to the User and, if selected, to a concierge or police etc.

Short Term Normal Storage as Part of Everyday Use and Transportation.

a. The RFID Instrument Presence Sensor turns on for a status check to log an RFID tagged Instrument's presence. If the Instrument is present and recognized, it hibernates. If no, it trips BLE and 3G reporting.

b. The Humidity Monitor set on for slow sample rate: for example, 1 time per day, with a report cycle of 1 time per day.

c. The Temperature Monitor set for medium sample rate: for example, 4 times per hour, reporting if the temperature range is exceeded.

d. The Accelerometer off but on Mobile App front page. It can be turned on if the case is temporarily “parked.” If on, it triggers the GPS, tracking location data to an internal log.

e. The GPS, if triggered tracks the GPS location data and triggers the BLE and 3G broadcast.

f. The BLE, if triggered, wakes and transmits every 2 minutes or per User setting.

g. The 3G, if triggered, wakes and sends a message to the User and, if selected, to a concierge or police etc.

h. The User can remotely modify 3G signal transmission function to update and react to the current GPS position.

i. The User can remotely test the RFIS Instrument Presence Sensor and get results.

4. Travel Mode

a. The RFID Instrument Presence Sensor turns on for a status check to log Instrument presence data. If yes, it hibernates. If no, it trips BLE and 3G broadcasts. The RFID Instrument Presence Sensor can be set to check the Instrument's presence at a preferred interval, say, every 5 minutes at either end of a flight.

b. The Humidity Monitor set on for slow sample rate: for example, 1 time per day, with a report cycle of 1 time per day.

c. The Temperature Monitor set for medium sample rate: 4 times per hour, reporting if the User's or Manufacturer's preferred or recommended temperature range is exceeded.

d. The Accelerometer is on. The User is prompted to take 2 to 4 condition cell phone photos before travel, time stamped and stored as “before” shots in case of handling damage during travel. These can be compared to time stamped “after” photos in case of damage.

e. The GPS is off. It is programmed to log location at an Accelerometer event. It can be remotely pinged in instance of a lost case to report current position using the 3G broadcast.

f. The BLE is off. It can be remotely triggered by 3G for data synchronization when in proximity to a cell phone to which it is paired.

g. The 3G, if triggered, wakes and sends a message to the User and, if selected, to a concierge or police etc.

h. The User can remotely modify the 3G signal transmission with the Instrument's current GPS position.

i. The User can remotely test the RFID Instrument Presence Sensor and get results.

j. On arrival and inspection, the User can add time stamped cell phone photos of damage.

5. Manufacturer Storage Environment Requirement in Normal Use

a. An Instrument Manufacturer may extend warranty over typical dryness or excess humidity damage if the RFID Instrument Presence Sensor is set to confirm that the instrument is in the case with humidity and temperature within the Manufacturer's designated “ok” range. This might be set to require 3 out of 5 yes tests over each 24 hour period.

b. The Humidity Monitor turns on for slow sample rate: for example, 1 time per day, with a report cycle of 1 time per day.

c. The Temp Monitor turns on for slow sample rate: for example, 1 time per day, with a report cycle of 1 time per day.

d. The Accelerometer is off. Theft/disturbance concern is nil.

e. The BLE turns on for reporting, say, 1 time per day at 10 p.m. or per the User's setting.

f. The GPS is off.

g. The 3G broadcast is off.

As can be seen, an improved monitoring device for detecting environmental conditions is offered. The device may monitor conditions in a case containing a sensitive stringed instrument, or may be attached to the instrument itself for monitoring outside of a case. The device may also be built into an electronics unit such as a pre-amplifier or a tuner used as a case carried accessory or as an installed onboard unit. Such a device, built into or mounted on or incorporated into an instrument pre-amplifier can employ current monitoring circuitry to identify a connection to remote sound reinforcement, at which time the device's broadcasting modes can be turned off, reducing the possibility of RF interference during instrument use. In this way, conditions such as temperature, humidity, motion or location may be monitored even during use.

The monitoring device may also be used to monitor conditions for a case holding, for example, a camera, one or more bottles of wine, tennis racquets, and other environmentally-sensitive equipment or objects. It will be appreciated that the inventions herein are susceptible to modification, variation and change without departing from the spirit thereof.

I claim:

1. An environmental monitoring device configured to reside on or within an instrument, comprising:
a real time clock;
a first detector comprising an accelerometer operative to generate an acceleration signal in response to threshold movement of the device, and for determining a degree and duration associated with the threshold movements using the real time clock;
a second detector comprising a humidity sensor operative to generate humidity signals;
a third detector comprising a temperature sensor operative to generate temperature signals;
a processor for:
processing the acceleration signal to generate one or more movement events based on the threshold movements of the case as a function of time;
processing the humidity signals to generate a history of humidity within the case as a function of time; and
processing the temperature signals to generate a history of temperature within the case as a function of time; and
a first communications port configured to wirelessly communicate movement events, the determined durations associated with each movement event, and the humidity and temperature histories to a receiver remote from the device.

2. The monitoring device of claim 1, further comprising:
a fourth detector comprising a magnetometer sensor operative to generate directional orientation signals; and
wherein the processor further is for processing the directional orientation signals as a function of time.

3. The movement monitoring device of claim 2, wherein the first communications port comprises a transceiver configured to wirelessly transmit the processed signals.

4. The device of claim 3, wherein the transceiver communicates with a global positioning system (GPS) receiver for monitoring a geo-position of the instrument.

5. The device of claim 2, wherein the receiver is selected from the group of MP3 players, electronic PDAs, digital watches, cell phones and pagers.

6. The device of claim 5, wherein the receiver is operative to generate media signals suitable for display.

7. The device of claim 5, wherein the receiver is operative to synthesize the events as voice data.

8. The device of claim 5, wherein the first communications port communicates the events and generated work function to the receiver substantially continuously.

9. The device of claim 5, further comprising:
a battery configured to supply power to at least the processor and the transmitter.

10. The device of claim 5, further comprising: a magnetic field sensor.

11. The device of claim 5, further comprising:
a radio frequency identification tag or other identification tag.

12. The device of claim 5, wherein the sensitive instrument is an acoustic or electric stringed instrument, a horn, a drum, a camera, a piece of audio equipment, a keyboard instrument or a tennis racquet.

13. The device of claim 2, further comprising:
a second communications port configured to upload the movement events and the humidity and temperature histories to a general purpose computer.

14. A method for monitoring the condition of a stringed instrument, comprising:
placing the stringed instrument within a case;
placing a monitoring device within the case, the monitoring device comprising:
a first detector comprising an accelerometer operative to generate a motion signal in response to movements of the device, and for determining a duration associated with the movements;
a second detector comprising a humidity sensor operative to generate humidity signals;
a third detector comprising a temperature sensor operative to generate temperature signals;
a fourth detector comprising a magnetometer sensor operative to generate directional orientation signals;
a processor for processing the motion signals, the temperature signals, the directional orientation signals and the humidity signals, and for recording these signals as a function of time; and
a transceiver for broadcasting wireless signals indicative of the motion signals, the temperature signals and the humidity signals as a function of time; and
receiving the wireless signals using a remote user processor.

15. A method for monitoring the condition of a stringed instrument, comprising:
placing a monitoring device within the instrument, the monitoring device comprising:
a first detector comprising an accelerometer operative to generate a motion signal in
response to movements of the device, and for determining a duration associated with the movements;
a second detector comprising a humidity sensor operative to generate humidity signals; a third detector comprising a temperature sensor operative to generate temperature signals;
a fourth detector comprising a magnetometer sensor operative to generate directional orientation signals;
a processor for processing the motion signals, the temperature signals and the humidity signals, and for recording these signals as a function of time; and
a transceiver for broadcasting wireless signals indicative of the motion signals, the temperature signals and the humidity signals as a function of time; and
receiving the wireless signals using a remote user processor.

16. The method of claim 15, wherein:
the processor further comprises a fourth detector comprising a geo-location sensor operative to generate geo-position signals; and
the wireless signals are further indicative of the geo-position signals as a function of time.

17. The method of claim 16, wherein a wireless signal is sent in response to threshold events.

18. The method of claim 17, wherein the threshold event comprises (i) a temperature reading that is above a designated threshold; (ii) a temperature reading that is below a designated threshold; (iii) a humidity reading that is above a designated threshold; (iv) a humidity reading that is below a designated threshold; (v) any movement of the case; (vi) movement of the case outside of a designated boundary; (vii) sudden movement of the case indicative of being mishandled; and (viii) combinations thereof.

19. The method of claim 18, further comprising:
analyzing environmental history of the case in response to receiving the wireless signals.

20. The method of claim 19, further comprising:
in response to analyzing the data, (i) making a warranty claim for the contents of the case, (ii) submitting an insurance claim for the contents of the case, or (iii) presenting a claim for damages for the contents of the case.

21. The method of claim 16, wherein wireless signals are sent continuously.

22. The method of claim 21, further comprising:
processing the humidity signals of the wireless signals to generate a history of humidity within the instrument as a function of time; and
processing the temperature signals of the wireless signals to generate a history of temperature within the case as a function of time.

23. A portable device for detecting and compiling environmental data, and for communicating the environmental data to a remote location, the monitoring device comprising:
a housing adapted to be placed within an instrument;
a temperature detector disposed within the housing for generating electrical signals indicative of temperature;
a humidity detector disposed within the housing for generating electrical signals indicative of humidity;
a movement detector disposed within the housing for generating electrical signals indicative of movement of the housing;
a geo-position detector disposed within the housing for generating electrical signals indicative of location of the housing;
a processing device disposed within the housing, the processing device being in electrical communication with each of the detectors, the processing device receiving the electrical signals generated by the detectors, the processing device processing the received electrical signals to generate the environmental data, and also configured to store the generated environmental data; and
a transmitter disposed within the housing, the transmitter being in electrical communication with the processing device, the transmitter receiving the environmental data from the processing device upon being induced to do so by an occurrence of a particular environmental condition detected by a detector, the transmitter transmitting the environmental data to a remote receiver.

24. The monitoring device of claim 23, further comprising:
a communications port configured to upload the stored environmental data to a general purpose computer.

25. The monitoring device of claim 23, further comprising:
an RFID identifier, the identifier comprising a transmitter that detects the presence of an associated RFID tag associated with an object being monitored, the RFID identifier being configured to send a signal to the processing device when the RFID tag is detected, causing the detectors to begin sensing environmental conditions.

26. The monitoring device of claim 23, wherein the processing device is programmed to enter into a “sleep” mode during selected intervals to conserve battery power.

27. The monitoring device of claim 26, wherein the device communicates with and is programmed through an application residing on a mobile computing device app providing predefined or user defined power management templates based on event parameter triggers.

28. The monitoring device of claim 27, wherein the app provides a user interface whereby a user may customize reporting and recording history of the device.
